(19) United States
(12) Patent Application Publication
(10) Pub. No.: US 2003/0057275 A1
(43) Pub. Date: Mar. 27, 2003

(54) Method and apparatus for display in a fuel dispenser

(76) Inventors: Clyde Wayne Koenig, Austin, TX (US); Bijan Noor, Austin, TX (US); David A. Biedermann, Austin, TX (US)

Correspondence Address: P. Weston Musselman, Jr., Esq., Jenkens & Gilchrist, P.C., 3200 Fountain Place, 1445 Ross Avenue, Dallas, TX, 75202-2799, US

(21) Appl. No.: 09/965,391

(22) Filed: Sep. 27, 2001

(51) Int. Cl. G06F 7/08

(52) U.S. Cl. 235/381

(57) ABSTRACT

According to one embodiment for display in a fuel dispenser, a display is connected to a printed circuit board. A light source is interposed between the display and the printed circuit board for illuminating the display.

### BACKGROUND

This description relates in general to electronic displays, and in particular to a method and apparatus for display in a fuel dispenser.

In an outdoor environment, a liquid crystal display (“LCD”) is useful for displaying information to a user of a fuel dispenser. Such information is displayed for a transaction in which fuel is dispensed during the user's operation of the dispenser. For example, such information includes (a) a total volume of fuel dispensed in the transaction (“Gallons”) and (b) a total fee owed in exchange for such dispensed fuel in the transaction (“Sale”).

Such information is preferably visible and readable under a variety of ambient lighting conditions, such as darkness or direct sunlight. To enhance such visibility and readability, the fuel dispenser can include a separate light source for backlighting the LCD. Nevertheless, previous techniques for such backlighting have various shortcomings.

Accordingly, a need has arisen for a method and apparatus for display in a fuel dispenser, in which various shortcomings of previous techniques are overcome.

### SUMMARY

According to one embodiment, for display in a fuel dispenser, a display is connected to a printed circuit board. A light source is interposed between the display and the printed circuit board for illuminating the display.

A principal advantage of these embodiments is that various shortcomings of previous techniques are overcome.

### BRIEF DESCRIPTION OF THE DRAWINGS

FIG. 1 is an illustration of a fuel dispenser, according to the illustrative embodiments.

FIG. 2 is a block diagram of various components of the fuel dispenser of FIG. 1.

FIG. 3 is an illustration of a frontal view of a liquid crystal display (“LCD”) of the fuel dispenser of FIG. 1.

FIG. 4 is an illustration of a frontal view of a light emitting diode (“LED”) light source for backlighting the display of FIG. 3, according to a first illustrative embodiment.

FIG. 5 is an illustration of a side view of an assembly including the LED light source of FIG. 4 interposed between a printed circuit board (“PCB”) and the LCD of FIG. 3, according to the first illustrative embodiment.

FIG. 6 is an illustration of a frontal view of the assembly of FIG. 5.

FIG. 7 is a schematic electrical circuit diagram of the LED light source of FIG. 4 connected to a power source.

FIG. 8 is an illustration of a side view of an assembly including a PCB interposed between a light source and the LCD of FIG. 3, according to an alternative version of the first illustrative embodiment.

FIG. 9 is an illustration of a side view of an assembly including a cold cathode fluorescent lamp (“CCFL”) light source interposed between a PCB and the LCD of FIG. 3, according to a second illustrative embodiment.

FIG. 10 is an illustration of a three-dimensional perspective view of the assembly of FIG. 9.

FIG. 11 is an illustration of a backlight assembly being removed from and/or inserted within the assembly of FIG. 10.

FIG. 12 is an illustration of a side view of an assembly including a PCB interposed between a CCFL light source and the LCD of FIG. 3, according to an alternative version of the second illustrative embodiment.

FIG. 13 is an illustration of a three-dimensional perspective view of the assembly of FIG. 12.

### DETAILED DESCRIPTION

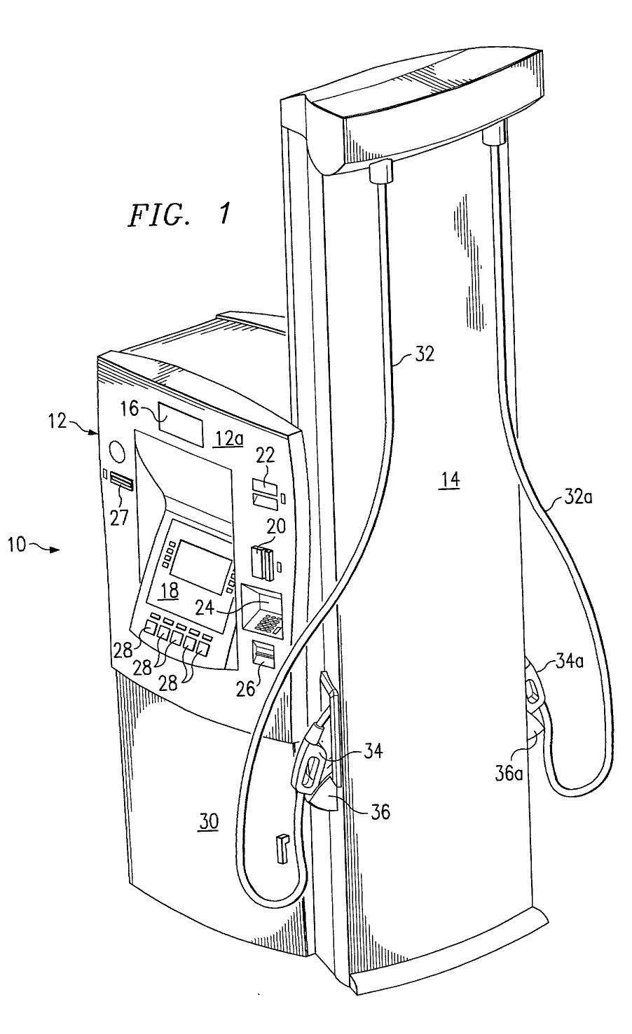

FIG. 1 is an illustration of a fuel dispenser, indicated generally at 10, according to an illustrative embodiment. Dispenser 10 includes a housing 12 and a hose tower 14 adjacent to housing 12. Housing 12 includes a front panel 12a.

A side portion of panel 12a overlaps a portion of hose tower 14. An upper portion of panel 12a includes a display 16 for displaying information (e.g. relating to dispensing of fuel) for viewing by a user of fuel dispenser 10. Near display 16, dispenser 10 includes a recessed display 18 for displaying other information for viewing by the user.

Near display 18, dispenser 10 includes a credit card reader 20, a bar code scanner 22, a numerical keypad 24, a receipt dispenser 26, a bill acceptor 27, and a group of octane select buttons 28. Also, a door 30 encloses a compartment (not shown) in a lower portion of housing 12 beneath panel 12a. Door 30 is detachably connected to housing 12 in a conventional manner (e.g. by hinges, screws and bolts), so that the compartment is accessible.

The compartment contains equipment, such as a conduit (not shown) that extends to an underground storage tank for fuel to be dispensed. The conduit is coupled through hose tower 14 to a first end of a hose 32. A second end of hose 32 is connected to a nozzle 34 for dispensing fuel to a container (e.g. a vehicle's fuel tank). Hose tower 14 includes a boot 36 for receiving nozzle 34 during periods of inactivity.

Similarly, the conduit is coupled through hose tower 14 to a first end of a hose 32a. A second end of hose 32a is connected to a nozzle 34a for dispensing fuel to a container. Hose tower 14 includes a boot 36a for receiving nozzle 34a during periods of inactivity.

FIG. 2 is a block diagram of various components of dispenser 10, including display 16, fuel dispensing equipment 40, and electronic control circuitry 42. Control circuitry 42 (e.g. including a microprocessor) is mounted behind front panel 12a. Display 16 displays information for a transaction in which fuel is dispensed during a user's operation of dispenser 10.

Accordingly, in the illustrative embodiments, display 16 displays (a) a total volume of fuel dispensed in the transaction (“Gallons”) and (b) a total fee owed in exchange for such dispensed fuel in the transaction (“Sale”). Control circuitry 42 is programmed to store information, such as a price per volume. Also, during a transaction in which fuel is dispensed, control circuitry 42 receives signals from fuel dispensing equipment 40 (e.g. a fuel volume measurement unit).

In response to such signals from fuel dispensing equipment 40 (e.g. signals representative of fuel volume), control circuitry 42 performs suitable calculations (e.g. in response to price per volume) and outputs signals to display 16 for the transaction. In response to such signals from control circuitry 42, display 16 displays Gallons and Sale information for the transaction. In alternative embodiments, in response to additional signals from control circuitry 42, display 16 displays additional information, such as price per volume, grade of fuel being dispensed (e.g. in terms of octane rating), instructions to guide a user through various predispensing and dispensing steps (e.g. type of payment, octane rating selection), and other information (e.g. in response to a user's operation of numerical keypad 24).

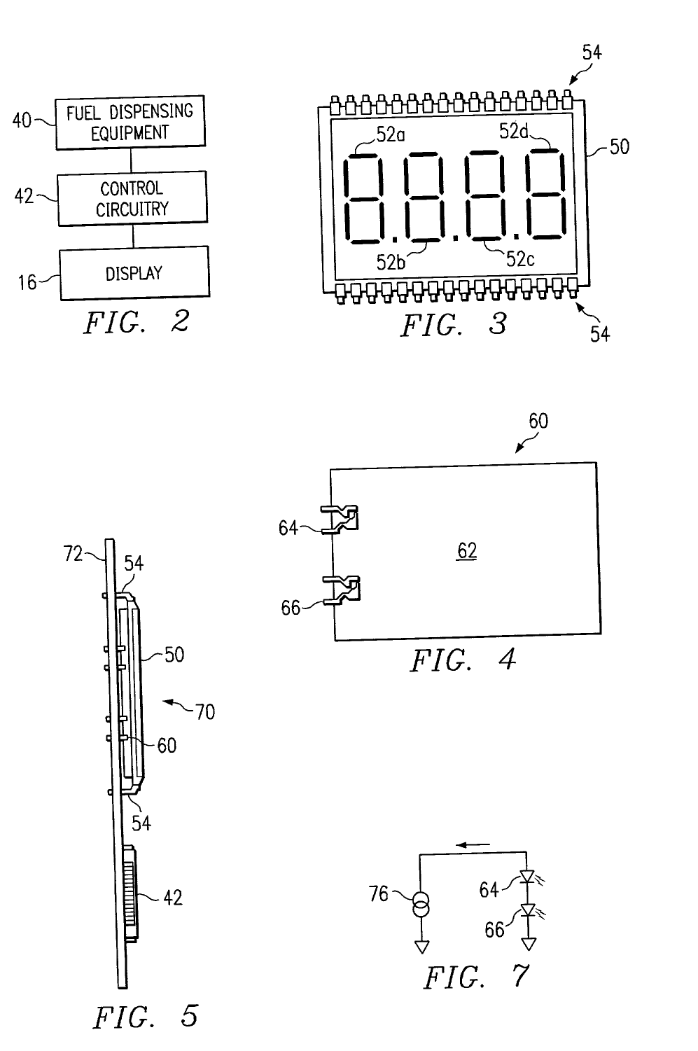

FIG. 3 is an illustration of a frontal view of a translucent liquid crystal display (“LCD”) module 50 of display 16 (FIG. 1). LCD module 50 is transflective, so it can be viewed (a) reflectively with incidental light and/or (b) transmissively with backlighting. Accordingly, in the illustrative embodiments, a light source provides backlighting for LCD module 50, as discussed further hereinbelow in connection with FIGS. 4-13.

LCD module 50 is a representative one of multiple LCD modules, which are substantially identical to one another, and which together form display 16. As shown in FIG. 3, LCD module 50 includes four numeric characters (with seven elements per character) 52a, 52b, 52c and 52d; however, in certain applications, LCD module 50 includes six numeric characters instead of four. Also, LCD module 50 includes multiple electrical connectors, indicated generally at 54, for electrically coupling to (and receiving signals from) control circuitry 42.

FIG. 4 is an illustration of a frontal view of a light emitting diode (“LED”) light source, indicated generally at 60, for backlighting LCD module 50, according to a first illustrative embodiment. LED light source 60 includes a flat carrier panel housing 62 and multiple LEDs 64 and 66 connected to (and along) a first end of housing 62. LEDs 64 and 66 provide edge lighting in a selected one of various colors (e.g. red, green, amber, blue or white). In the first illustrative embodiment, the color is white.

FIG. 5 is an illustration of a side view of an assembly, indicated generally at 70, including LED light source 60 interposed between a printed circuit board (“PCB”) 72 and LCD module 50, according to the first illustrative embodiment. As shown in FIG. 5, LCD module 50, LED light source 60, and control circuitry 42 are physically connected to (or mounted to) PCB 72, so that PCB 72 operates as a housing therefor. LCD module 50 and control circuitry 42 are electrically coupled to one another, as discussed further hereinabove in connection with FIG. 3.

LCD 50 and control circuitry 42 receive power from PCB 72. In the first illustrative embodiment, LED light source 60 likewise receives power from PCB 72. In an alternative version of the first embodiment, LED light source 60 receives power from a different power source external to PCB 72, and such an external connection enhances field replaceability of LED light source 60, apart from PCB 72 and LCD module 50. LED light source 60 receives power from a direct current (“DC”) power source, such as a battery, which substantially avoids incompatibilities that might otherwise result from geographic variations in the availability of 110 volt and 220 volt alternating current (“AC”) power.

LED light source 60 is located directly behind LCD module 50. For example, as shown in FIG. 5, LED light source 60 (having a thickness of approximately 0.06 inches) is interposed between LCD module 50 and PCB 72. In that manner, LED light source 60 provides efficient, smooth, evenly distributed lighting for LCD module 50.

In comparison to alternative techniques (e.g. fluorescent light source or incandescent light source), assembly 70 (including LED light source 60) achieves reduced power consumption, reduced wiring, higher reliability and life expectancy, wider operating temperature range, reduced heat emission, and financial cost savings. By reducing power consumption (and heat emission), assembly 70 has less need for additional cooling (e.g. less need for a fan to circulate external air), so financial cost savings are achieved, reliability is increased, and environmental concerns are more readily addressed.

By reducing complexity (e.g. in PCB 72) and achieving financial cost savings, LED light source 60 is dedicated to backlighting its associated LCD module 50, so that other LED light sources are likewise dedicated to backlighting their own respectively associated LCD modules. In that manner, a single LED light source is not shared between multiple LCD modules. Accordingly, in that manner, multiple LCD modules (such as LCD module 50) are more readily arranged within fuel dispenser 10, without mandating close physical proximity between multiple LCD modules that might otherwise have shared a single LED light source.

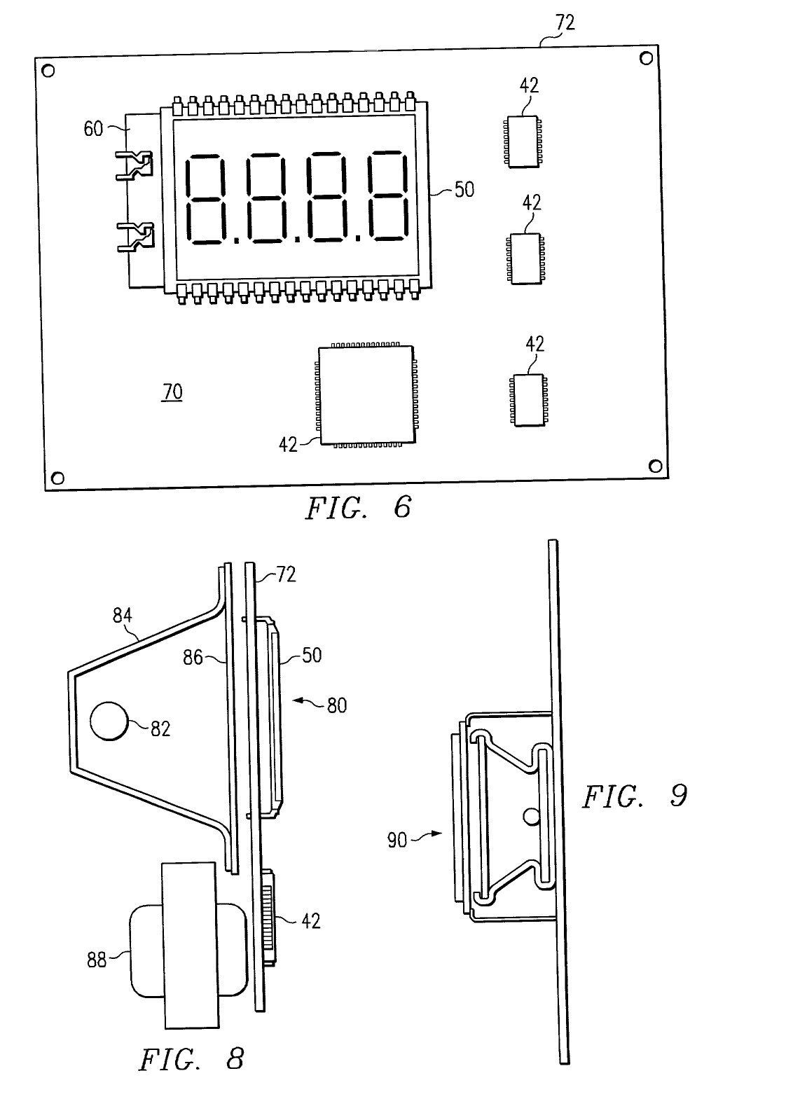

FIG. 6 is an illustration of a frontal view of assembly 70. Preferably, for aesthetic reasons, when LCD module 50 is viewed by a user of fuel dispenser 10, LED light source 60 is substantially obscured from the user's view.

FIG. 7 is a schematic electrical circuit diagram of LED light source 60 connected to a power source. As shown in FIG. 7, LEDs 64 and 66 are electrically coupled to a current source 76 (e.g. 28 milliamp current source), which provides power, so that electrical current flows through LEDs 64 and 66. In response to such flow of current, LEDs 64 and 66 illuminate and accordingly emit light.

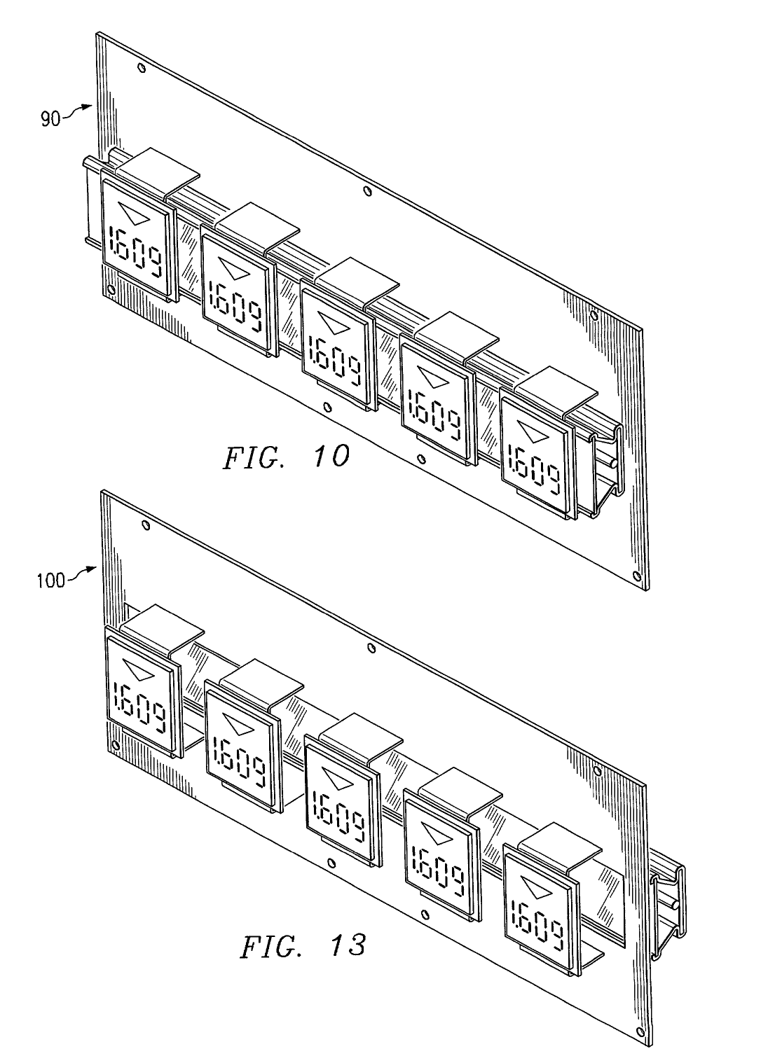

FIG. 8 is an illustration of a side view of an assembly, indicated generally at 80, including PCB 72 interposed between a light source 82 and LCD module 50, according to an alternative version of the first illustrative embodiment. Assembly 80 varies from assembly 70 in various ways. For example, in assembly 80, PCB 72 has an aperture through which light source 82 emits light for backlighting LCD module 50. Such an aperture is not required in assembly 70, because LED light source 60 (in assembly 70) is interposed between LCD module 50 and PCB 72.

Also, for enhanced lighting, assembly 80 includes a backlight assembly. The backlight assembly includes (a) light source 82, (b) a light reflector/carrier 84 for reflecting light that is emitted from light source 82, so that such light is directed toward LCD module 50, and (c) a light diffuser 86 for diffusing light that is emitted from light source 82 (or reflected from reflector/carrier 84) en route to LCD module 50. In the backlight assembly, light source 82 and diffuser 86 are physically connected to reflector/carrier 84. In one embodiment, reflector/carrier 84 is physically connected to PCB 72. In an alternative embodiment, reflector/carrier 84 is physically connected to another portion of fuel dispenser 10.

In one embodiment, light source 82 is an LED light source, such as LED light source 60. In an alternative embodiment, light source 82 is either a fluorescent light source or an incandescent light source. In such an alternative embodiment, light source 82 receives power from an AC power source 88.

FIG. 9 is an illustration of a side view of an assembly, indicated generally at 90, including a cold cathode fluorescent lamp (“CCFL”) light source interposed between a PCB and LCD module 50, according to a second illustrative embodiment. FIG. 10 is an illustration of a three-dimensional perspective view of assembly 90. FIG. 11 is an illustration of a backlight assembly being removed from and/or inserted within assembly 90. FIGS. 10 and 11 show multiple LCD modules (including LCD module 50), which are substantially identical to one another, and which together form display 16.

In the second illustrative embodiment, the CCFL light source provides backlighting for LCD module 50. The CCFL light source provides direct lighting rather than edge lighting. With assembly 90, LCD module 50 is illuminated (by the CCFL light source) more brightly in comparison to edge lighting techniques. In comparison to a conventional fluorescent lamp, the CCFL light source is more compact, brighter and has a longer life. Also, like LED light source 60, the CCFL light source receives power from a DC power source, such as a battery, which substantially avoids incompatibilities that might otherwise result from geographic variations in the availability of 110 volt and 220 volt AC power.

Assembly 90 combines various features of assemblies 70 and 80. For example, like assembly 70, the PCB of assembly 90 is not required to have an opening for light to pass through LCD display module 50, because the CCFL light source is interposed between the PCB and LCD module 50. Accordingly, like assembly 70, the PCB of assembly 90 is advantageously smaller and less expensive.

Like assembly 80, assembly 90 includes a backlight assembly. As shown in FIG. 9, the backlight assembly includes (a) the CCFL light source, (b) a light reflector/carrier for reflecting light that is emitted from the CCFL light source, so that such light is directed toward LCD module 50, and (c) a light diffuser for diffusing light that is emitted from the CCFL light source (or reflected from the reflector/carrier) en route to LCD module 50. Moreover, the CCFL light source is physically connected to a CCFL PCB, which is also part of the backlight assembly. The backlight assembly also includes a power connector (not shown in FIG. 9) for connecting the CCFL light source to a power source that is external to the backlight assembly, so that the CCFL light source receives power from such power source in a manner that enhances field replaceability of the backlight assembly, apart from the PCB and LCD module 50.

In the backlight assembly, the CCFL PCB and the diffuser are physically connected to the reflector/carrier. In turn, the reflector/carrier (and, accordingly, the entire backlight assembly) is insertable into or removable from assembly 90, as shown in FIG. 11, so that the backlight assembly is field replaceable, apart from the PCB and LCD module 50. After inserting the backlight assembly into assembly 90, the backlight assembly is physically latched in a static position. Before removing the backlight assembly from assembly 90, the backlight assembly is physically unlatched from the static position. As shown in FIGS. 9, 10 and 11, the entire backlight assembly is interposed between the PCB and LCD module 50.

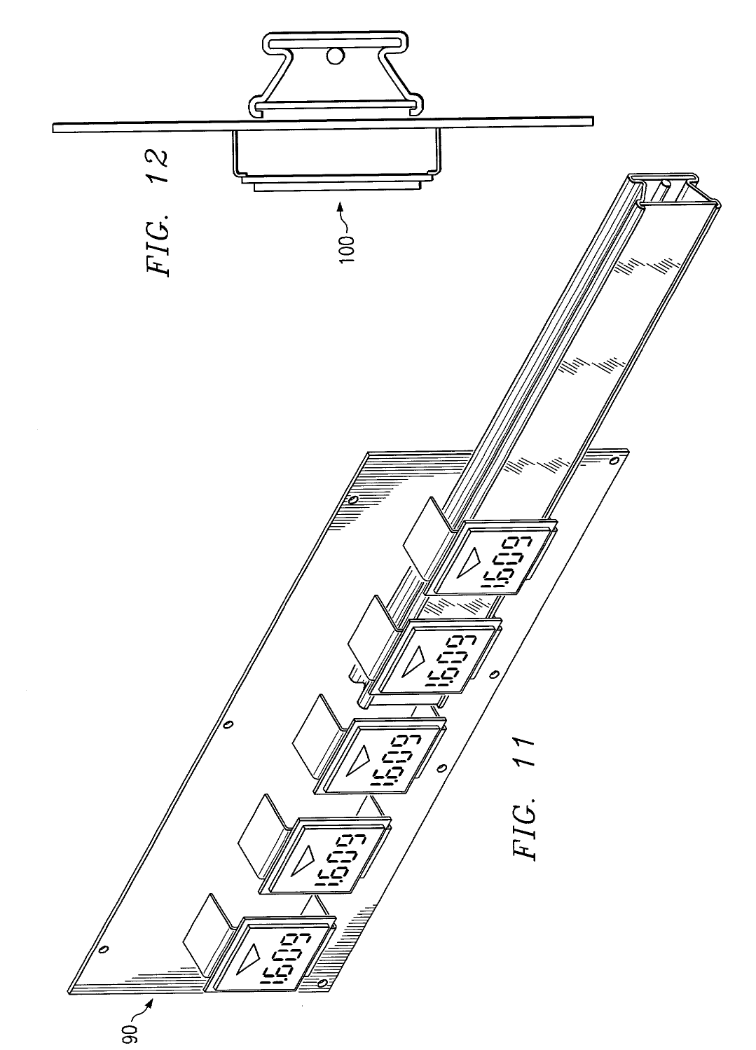

FIG. 12 is an illustration of a side view of an assembly, indicated generally at 100, including the PCB interposed between the CCFL light source and LCD module 50, according to an alternative version of the second illustrative embodiment. Assembly 100 varies from assembly 90. For example, in assembly 100, the PCB has an aperture through which the CCFL light source emits light for backlighting LCD module 50. Such an aperture is not required in assembly 90, because the CCFL light source (in assembly 90) is interposed between LCD module 50 and the PCB.

FIG. 13 is an illustration of a three-dimensional perspective view of assembly 100. Like assembly 90, the backlight assembly of assembly 100 is field replaceable, apart from the PCB and LCD module 50.

Although illustrative embodiments have been shown and described, a wide range of modification, change and substitution is contemplated in the foregoing disclosure and, in some instances, some features of the embodiments may be employed without a corresponding use of other features. Accordingly, it is appropriate that the appended claims be construed broadly and in a manner consistent with the scope of the embodiments disclosed herein. Spatial references (e.g. “above,” “below,” “side,” “front,” and “rear”) in the foregoing disclosure are merely for illustrative purposes and do not limit specific orientations or locations of structures in the embodiments.

What is claimed is:

1. Apparatus for display in a fuel dispenser, comprising:
a printed circuit board;
a display connected to the printed circuit board; and
a light source interposed between the display and the printed circuit board for illuminating the display.

2. The apparatus of claim 1 wherein the display includes a liquid crystal display module.

3. The apparatus of claim 1 wherein the light source includes a light emitting diode.

4. The apparatus of claim 1 wherein the light source includes a fluorescent lamp.

5. The apparatus of claim 4 wherein the fluorescent lamp is a cold cathode fluorescent lamp.

6. The apparatus of claim 1 and comprising an assembly including the light source.

7. The apparatus of claim 6 wherein the assembly is field replaceable, apart from the printed circuit board and the display.

8. The apparatus of claim 6 wherein the assembly includes a reflector for reflecting light that is emitted from the light source, so that the light is directed toward the display.

9. The apparatus of claim 6 wherein the assembly includes a diffuser for diffusing light that is emitted from the light source en route to the display.

10. The apparatus of claim 1 wherein the display is for displaying information to a user of the fuel dispenser, and comprising:
circuitry for outputting signals to the display, so that the display displays the information in response to the signals.

11. Apparatus for display in a fuel dispenser, comprising:
a printed circuit board;
a liquid crystal display module connected to the printed circuit board for displaying information to a user of the fuel dispenser;
circuitry for outputting signals to the liquid crystal display module, so that the liquid crystal display module displays the information in response to the signals;
an assembly including a light source, the light source being interposed between the liquid crystal display module and the printed circuit board for illuminating the liquid crystal display module.

12. The apparatus of claim 11 wherein the light source includes a light emitting diode.

13. The apparatus of claim 11 wherein the light source includes a cold cathode fluorescent lamp.

14. The apparatus of claim 11 wherein the assembly is field replaceable, apart from the printed circuit board and the liquid crystal display module.

15. The apparatus of claim 11 wherein the assembly includes a reflector for reflecting light that is emitted from the light source, so that the light is directed toward the liquid crystal display module.

16. The apparatus of claim 11 wherein the assembly includes a diffuser for diffusing light that is emitted from the light source en route to the liquid crystal display module.

17. A method of display in a fuel dispenser, comprising:
connecting a display to a printed circuit board; and
interposing a light source between the display and the printed circuit board for illuminating the display.

18. The method of claim 17 wherein the connecting comprises:
connecting the display to the printed circuit board, the display including a liquid crystal display module.

19. The method of claim 17 wherein the interposing comprises:
interposing the light source between the display and the printed circuit board, the light source including a light emitting diode.

20. The method of claim 17 wherein the interposing comprises:
interposing the light source between the display and the printed circuit board, the light source including a fluorescent lamp.

21. The method of claim 17 wherein the interposing comprises:
interposing the light source between the display and the printed circuit board, the light source including a cold cathode fluorescent lamp.

22. The method of claim 17 and comprising:
field replacing an assembly including the light source, apart from the printed circuit board and the display.

23. The method of claim 17 and comprising:
outputting signals to the display, so that the display displays information to a user of the fuel dispenser in response to the signals.
